(19) United States
(12) Patent Application Publication
(10) Pub. No.: US 2025/0077092 A1
(43) Pub. Date: Mar. 6, 2025

(54) SYSTEMS AND METHODS FOR BUFFER DATA PRESERVATION

(71) Applicant: Samsung Electronics Co., Ltd., Suwon-si (KR)

(72) Inventors: Byung CHOI, Fremont, CA (US); Tong ZHANG, Mountain View, CA (US); Changho CHOI, San Jose, CA (US)

(21) Appl. No.: 18/511,907

(22) Filed: Nov. 16, 2023

Related U.S. Application Data
(60) Provisional application No. 63/536,653, filed on Sep. 5, 2023.

(51) Int. Cl. G06F 3/06

(52) U.S. Cl. CPC G06F 3/0619; G06F 3/0656; G06F 3/0679

(57) ABSTRACT

Systems and methods for buffer data preservation. In some embodiments, the method includes: receiving, by a persistent storage device including non-volatile memory and a buffer storing data, a first memory-addressed instruction; and copying a portion of the data in the buffer of the persistent storage device to the non-volatile memory, based on receiving the first memory-addressed instruction.

### CROSS-REFERENCE TO RELATED APPLICATION(S)

The present application claims priority to and the benefit of U.S. Provisional Application No. 63/536,653, filed Sep. 5, 2023, entitled “DYNAMIC BUFFER/CACHE FLUSH FOR SECURE DATA PROTECTION IN CXL AND MEMORY DEVICE SYSTEMS”, the entire content of which is incorporated herein by reference.

### FIELD

One or more aspects of embodiments according to the present disclosure relate to persistent storage devices, and more particularly to a system and method for external-command-initiated buffer flush in a persistent storage device.

### BACKGROUND

A persistent storage device may include a buffer, which may include (for example, be composed of) volatile memory. Being composed of volatile memory, the contents of the buffer may be lost if external power to the persistent storage device is interrupted. As such, the persistent storage device may include an energy storage device for temporarily powering the persistent storage device if external power to the persistent storage device is interrupted.

It is with respect to this general technical environment that aspects of the present disclosure are related.

### SUMMARY

According to an embodiment of the present disclosure, there is provided a method including: receiving, by a persistent storage device including non-volatile memory and a buffer storing data, a first memory-addressed instruction; and copying a portion of the data in the buffer of the persistent storage device to the non-volatile memory, based on receiving the first memory-addressed instruction.

In some embodiments, the portion of the buffer is specified by a start address in a start address register of the persistent storage device and an end address in an end address register of the persistent storage device.

In some embodiments: the portion of the buffer has a first size, and the first size is based on a value in a first register of the persistent storage device.

In some embodiments, the method further includes: determining that a first portion of the buffer stores host data; and determining that a second portion of the buffer stores data generated by the persistent storage device.

In some embodiments, the method further includes: determining that a first portion of the buffer stores host data; and determining that a second portion of the buffer stores data generated by the persistent storage device, wherein: the copying of a portion of the data in the buffer of the persistent storage device to the non-volatile memory includes copying a part of the first portion of the buffer.

In some embodiments, the method further includes: determining that a first portion of the buffer stores host data; reading, by the persistent storage device, first data from the non-volatile memory; processing the first data, by the persistent storage device, to form first processed data; storing, by the persistent storage device, the first processed data in a second portion of the buffer; and determining that the second portion of the buffer stores data generated by the persistent storage device, wherein: the copying of a portion of the data in the buffer of the persistent storage device to the non-volatile memory includes copying a part of the first portion of the buffer.

In some embodiments, the method further includes: receiving, by the persistent storage device, a second memory-addressed instruction; and sending, by the persistent storage device, an indication of a quantity of data stored in the buffer, based on the receiving, by the persistent storage device, of the second memory-addressed instruction.

In some embodiments, the method further includes: determining that a first portion of the buffer stores host data; determining that a size of the first portion exceeds a threshold; and copying a part of the first portion of the buffer to the non-volatile memory, based on determining that a size of the first portion exceeds a threshold.

In some embodiments, the method further includes: determining that a first portion of the buffer stores host data; determining that a size of the first portion exceeds a threshold by a first amount; and copying a part of the first portion of the buffer to the non-volatile memory, based on determining that a size of the first portion exceeds the threshold by the first amount, wherein a size of the part of the first portion is greater than or equal to the first amount.

In some embodiments, the method further includes: receiving, by the persistent storage device, a second memory-addressed instruction; and sending, by the persistent storage device, an indication of a quantity of host data stored in the buffer, based on the receiving, by the persistent storage device, of the second memory-addressed instruction.

According to an embodiment of the present disclosure, there is provided a system, including: a persistent storage device including: a non-volatile memory; a buffer; and a processing circuit configured: to store data in the buffer; to receive a first memory-addressed instruction; and to copy a portion of the data in the buffer to the non-volatile memory, based on receiving the first memory-addressed instruction.

In some embodiments: the processing circuit is further configured: to determine that a first portion of the buffer stores host data, and to determine that a second portion of the buffer stores data generated by the persistent storage device, and the copying of a portion of the data in the buffer of the persistent storage device to the non-volatile memory includes copying a part of the first portion of the buffer.

In some embodiments: the processing circuit is further configured: to determine that a first portion of the buffer stores host data; to read first data from the non-volatile memory; to process the first data, to form first processed data; to store the first processed data in a second portion of the buffer; and to determine that the second portion of the buffer stores data generated by the persistent storage device; and the copying of a portion of the data in the buffer of the persistent storage device to the non-volatile memory includes copying a part of the first portion of the buffer.

In some embodiments: the processing circuit is further configured: to receiving a second memory-addressed instruction; and to send an indication of a quantity of data stored in the buffer, based on the receiving of the second memory-addressed instruction.

In some embodiments: the processing circuit is further configured: to determine that a first portion of the buffer stores host data; to determine that a size of the first portion exceeds a threshold; and to copy a part of the first portion of the buffer to the non-volatile memory, based on determining that a size of the first portion exceeds a threshold.

In some embodiments: the processing circuit is further configured: to determine that a first portion of the buffer stores host data; to determine that a size of the first portion exceeds a threshold by a first amount; and to copy a part of the first portion of the buffer to the non-volatile memory, based on determining that a size of the first portion exceeds the threshold by the first amount, wherein a size of the part of the first portion is greater than or equal to the first amount.

In some embodiments: the processing circuit is further configured: to receive a second memory-addressed instruction; and to send an indication of a quantity of data stored in the buffer, based on the receiving of the second memory-addressed instruction.

According to an embodiment of the present disclosure, there is provided a persistent storage device, including: a persistent storage device including: a non-volatile memory; a buffer; a processing circuit; and memory, the memory storing instructions that, when executed by the processing circuit, cause the processing circuit to perform a method, the method including: receiving, by a persistent storage device including a buffer storing data and non-volatile memory, a first memory-addressed instruction; and copying a portion of the data in the buffer of the persistent storage device to the non-volatile memory, based on receiving the first memory-addressed instruction.

In some embodiments, the method further includes: determining that a first portion of the buffer stores host data; determining that a second portion of the buffer stores data generated by the persistent storage device; and the copying of a portion of the data in the buffer of the persistent storage device to the non-volatile memory includes copying a part of the first portion of the buffer.

In some embodiments, the method further includes: determining that a first portion of the buffer stores host data; reading, by the persistent storage device, raw data from the non-volatile memory; processing the raw data, by the persistent storage device, to form first processed data; storing, by the persistent storage device, the first processed data in a second portion of the buffer; determining that a second portion of the buffer stores data generated by the persistent storage device; and the copying of a portion of the data in the buffer of the persistent storage device to the non-volatile memory includes copying a part of the first portion of the buffer.

### BRIEF DESCRIPTION OF THE DRAWINGS

These and other features and advantages of the present disclosure will be appreciated and understood with reference to the specification, claims, and appended drawings wherein:

FIG. 1A is a block diagram of a host and a storage device, according to an embodiment of the present disclosure;

FIG. 1B is a block diagram of a storage device, according to an embodiment of the present disclosure;

FIG. 1C is a system level block diagram, according to an embodiment of the present disclosure;

FIG. 2 is a block diagram of a persistent storage device with an energy storage device, according to an embodiment of the present disclosure; and

FIG. 3 is a flow chart, according to an embodiment of the present disclosure.

### DETAILED DESCRIPTION

The detailed description set forth below in connection with the appended drawings is intended as a description of exemplary embodiments of a system and method for host-initiated buffer flush in a persistent storage device provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

In a computing system with a host and a persistent storage device, the host may periodically send write commands to the persistent storage device, for example, for the purpose of saving data (which may accompany the write command) to non-volatile memory of the persistent storage device. The persistent storage device may receive the write command and temporarily store the data in a buffer (which may include, or consist of, volatile memory). The use of a buffer may, for example, make possible data transfer bandwidths (for example, via direct memory access) between the host and the persistent storage device, that significantly exceed the bandwidth of the non-volatile memory of the persistent storage device.

The persistent storage device may include an energy storage device (for example, a battery or a capacitor) and in the event of a power failure, the persistent storage device may, to avoid data loss, consume power from the energy storage device while flushing, or “copying” data from the buffer to the non-volatile memory. Such copying of the data from the buffer to the non-volatile memory may be referred to as a global persistent flush (GPF). As used herein, “copying” of data includes flushing of data and moving of data (e.g., copying data from an original location to a new location and deleting the data from the original location).

As the technology of persistent storage devices evolves, the sizes of the buffers in such devices may increase significantly, and the energy storage capacity of the energy storage device may (if it is sized so as to be able to power the device while the entire buffer is copied to the non-volatile memory) become sufficiently large to significantly increase the cost of the persistent storage device or to constrain the packaging options for the persistent storage device.

In some embodiments, therefore, the energy storage device is sized so as to be able power the device while a portion of the buffer (which may be less than the entire buffer) is copied to the non-volatile memory. In such an embodiment, the persistent storage device may provide a mechanism for the host to trigger, or initiate, the copying of a portion of the buffer to the non-volatile memory of the persistent storage device. For example, the host may send a command to the persistent storage device to copy all of the data stored in the buffer to the non-volatile memory, or it may specify a portion of the buffer of the persistent storage device to be copied to the non-volatile memory of the persistent storage device. In this manner, the host may participate in the protection against data loss (and, for example, when instructing the persistent storage device to copy a portion of the buffer to non-volatile memory, the host may prioritize data that would be more difficult to recreate.

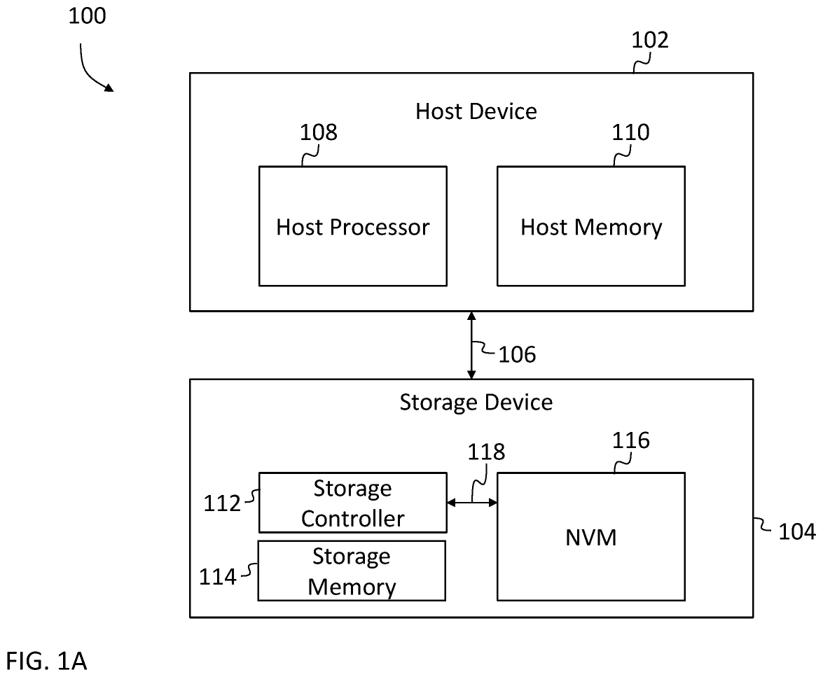

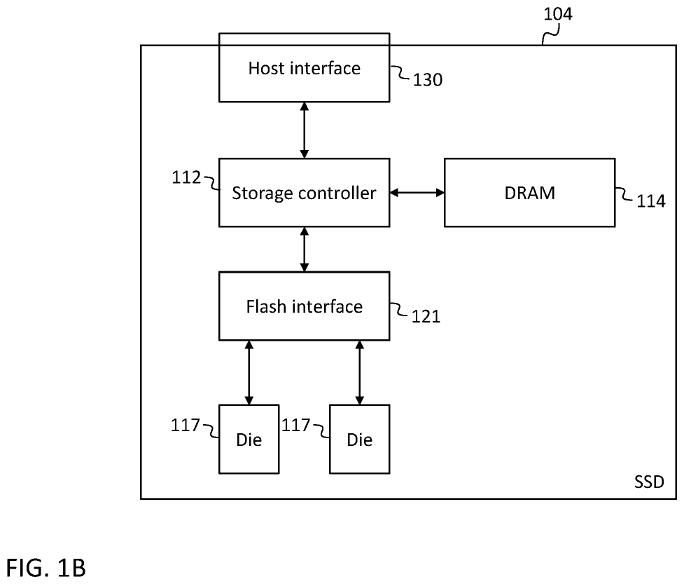

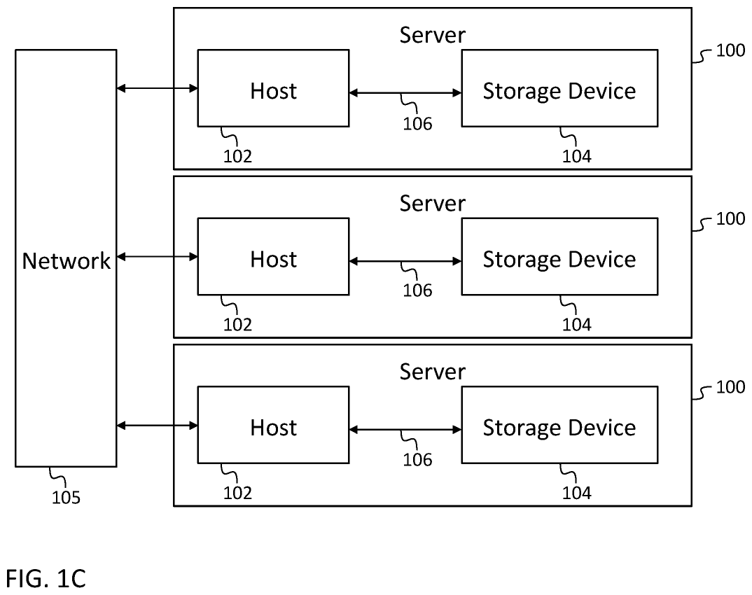

FIG. 1A illustrates a system, which may be referred to as a server 100, in accordance with some example embodiments of the disclosure. Referring to FIG. 1A, the server 100 may include a host device (or simply “host”) 102 and a storage device 104 (which may be a persistent storage device 104). In some embodiments, the host device 102 may be housed with the persistent storage device 104, and in other embodiments, the host device 102 may be separate from the persistent storage device 104. The host device 102 may include any suitable computing device connected to a persistent storage device 104 such as, for example, a personal computer (PC), a portable electronic device, a hand-held device, a laptop computer, or the like. The system of FIG. 1A may be employed to perform video processing. For example, as discussed in further detail below parallel decoding operations (for example, processing a first data unit (for example, a first component of a slice of a video frame, or a first slice) concurrently with a second data unit (for example, a second component of the slice, or a second slice)). In some embodiments, such parallel video decoding operations are performed in the persistent storage device 104 (which, in such an embodiment, may be referred to as a computational storage device).

The host device 102 may be connected to the persistent storage device 104 over a host interface 106. The host device 102 may issue data request commands or input-output (10) commands (for example, read or write commands) to the persistent storage device 104 over the host interface 106, and may receive responses from the persistent storage device 104 over the host interface 106.

The host device 102 may include a host processor 108 and host memory 110. The host processor 108 may be a processing circuit (discussed in further detail below), for example, such as a general-purpose processor or a central processing unit (CPU) core of the host device 102.

The host processor 108 may be connected to other components via an address bus, a control bus, a data bus, or the like. The host memory 110 may be considered as high performing main memory (for example, primary memory) of the host device 102. For example, in some embodiments, the host memory 110 may include (or may be) volatile memory, for example, such as dynamic random-access memory (DRAM). However, the present disclosure is not limited thereto, and the host memory 110 may include (or may be) any suitable high performing main memory (for example, primary memory) replacement for the host device 102 as would be known to those skilled in the art. For example, in other embodiments, the host memory 110 may be relatively high performing non-volatile memory, such as NAND flash memory, Phase Change Memory (PCM), Resistive RAM, Spin-transfer Torque RAM (STTRAM), any suitable memory based on PCM technology, memristor technology, or resistive random-access memory (ReRAM), and may include, for example, chalcogenides, or the like.

The persistent storage device 104 may operate as secondary memory that may persistently store data accessible by the host device 102. In this context, the persistent storage device 104 may include relatively slower memory when compared to the high performing memory of the host memory 110.

For example, in some embodiments, the persistent storage device 104 may be secondary memory of the host device 102, for example, such as a Solid-State Drive (SSD). However, the present disclosure is not limited thereto, and in other embodiments, the storage device 104 may include (or may be) any suitable storage device such as, for example, a magnetic storage device (for example, a hard disk drive (HDD), or the like), an optical storage device (for example, a Blue-ray disc drive, a compact disc (CD) drive, a digital versatile disc (DVD) drive, or the like), other kinds of flash memory devices (for example, a USB flash drive, and the like), or the like.

In various embodiments, the persistent storage device 104 may conform to a large form factor standard (for example, a 3.5 inch hard drive form-factor), a small form factor standard (for example, a 2.5 inch hard drive form-factor), an M.2 form factor, an E1.S form factor, or the like. In other embodiments, the persistent storage device 104 may conform to any suitable or desired derivative of these form factors. For convenience, the persistent storage device 104 may be described hereinafter in the context of a solid-state drive, but the present disclosure is not limited thereto.

The persistent storage device 104 may be communicably connected to the host device 102 over the host interface 106. The host interface 106 may facilitate communications (for example, using a connector and a protocol) between the host device 102 and the persistent storage device 104. In some embodiments, the host interface 106 may, for example, facilitate the exchange of storage requests (or “commands”) and responses (for example, command responses) between the host device 102 and the persistent storage device 104. In some embodiments, the host interface 106 may facilitate data transfers by the persistent storage device 104 to and from the host memory 110 of the host device 102.

For example, in various embodiments, the host interface 106 (for example, the connector and the protocol thereof) may include (or may conform to) Small Computer System Interface (SCSI), Non Volatile Memory Express (NVMe), Peripheral Component Interconnect Express (PCIe), Compute Express Link (CXL), remote direct memory access (RDMA) over Ethernet, Serial Advanced Technology Attachment (SATA), Fiber Channel, Serial Attached SCSI (SAS), NVMe over Fabric (NVMe-oF), or the like. In other embodiments, the host interface 106 (for example, the connector and the protocol thereof) may include (or may conform to) various general-purpose interfaces, for example, such as Ethernet, Universal Serial Bus (USB), and/or the like.

In some embodiments, the persistent storage device 104 may include a persistent memory controller (or “storage controller”) 112, storage memory 114 (which may also be referred to as a buffer), non-volatile memory (NVM) 116, and a storage interface 118. The storage memory 114 may be high-performing memory of the persistent storage device 104, and may include (or may be) volatile memory, for example, such as DRAM, but the present disclosure is not limited thereto, and the storage memory 114 may, for example, be any suitable kind of high-performing volatile or non-volatile memory.

The non-volatile memory 116 may persistently store data received, for example, from the host device 102. The non-volatile memory 116 may include, for example, NAND flash memory, but the present disclosure is not limited thereto, and the non-volatile memory 116 may include any suitable kind of memory for persistently storing the data according to an implementation of the persistent storage device 104 (for example, magnetic disks, tape, optical disks, or the like).

The persistent memory controller 112 may be connected to the non-volatile memory 116 over the storage interface 118. In the context of the SSD, the storage interface 118 may be referred to as flash channel, and may be an interface with which the non-volatile memory 116 (for example, NAND flash memory) may communicate with a processing component (for example, the persistent memory controller 112) or other device. Commands such as reset, write enable, control signals, clock signals, or the like may be transmitted over the storage interface 118.

In some embodiments, a software interface may be used in combination with a hardware element that may be used to test or verify the workings of the storage interface 118. The software may be used to read data from and write data to the non-volatile memory 116 via the storage interface 118. In some embodiments, the software may include firmware that may be downloaded onto hardware elements (for example, for controlling write, erase, and read operations).

The persistent memory controller 112 (which may be a processing circuit (discussed in further detail below)) may be connected to the host interface 106, and may, for example, manage signaling over the host interface 106. In some embodiments, the persistent memory controller 112 may include an associated software layer (for example, a host interface layer) to manage the physical connector of the host interface 106. The persistent memory controller 112 may respond to input or output requests received, for example, from the host device 102 over the host interface 106. The persistent memory controller 112 may also manage the storage interface 118, for example to control, and to provide access to and from, the non-volatile memory 116.

For example, the persistent memory controller 112 may include at least one processing component embedded therein for interfacing with the host device 102 and the non-volatile memory 116. The processing component may include, for example, a general purpose digital circuit (for example, a microcontroller, a microprocessor, a digital signal processor, or a logic device (for example, a field programmable gate array (FPGA), an application-specific integrated circuit (ASIC), or the like)) capable of executing data access instructions (for example, via firmware or software) to provide access to the data stored in the non-volatile memory 116 according to the data access instructions. For example, the data access instructions may correspond to the data request commands, and may include any suitable data storage and retrieval algorithm (for example, read, write, or erase) instructions, or the like.

FIG. 1B is a block diagram of a persistent storage device 104 (for example, a solid-state drive), in accordance with some example embodiments of the disclosure. The host interface 106 is used by the host 102, to communicate with the persistent storage device 104.

The data write and read input output commands, as well as various media management commands such as the non-volatile memory express (NVMe) Identify command and the NVMe Get Log command may be received, by the persistent storage device 104, through the host interface 106, the storage-device side of which may be implemented in the persistent storage device 104 by an interface circuit 130. The host interface 106 may also be used by the persistent storage device 104 to perform data transfers to and from host system memory. The persistent storage device 104 may store data in non-volatile memory 116 (for example, not-AND (NAND) flash memory), for example, in memory dies 117 containing memory cells, each of which may be (as discussed above), for example, a Single-Level Cell (SLC), a Multi-Level Cell (MLC), or a Triple-Level Cell (TLC). A Flash Translation Layer (FTL), which may be implemented in the persistent memory controller 112 (for example, based on firmware (for example, based on firmware stored in the non-volatile memory 116)) may provide a mapping between logical addresses used by the host and physical addresses of the data in the non-volatile memory 116.

The persistent storage device 104 may also include (i) a buffer (for example, the storage memory 114) (which may include, for example, consist of, dynamic random-access memory (DRAM)), and (ii) a flash interface (or “flash controller”) 121 for providing suitable signals to the memory dies 117 of the non-volatile memory 116. Some or all of the host interface 106, the Flash Translation Layer (as mentioned above), the storage memory 114 (for example, the buffer), and the flash interface 121 may be implemented in a processing circuit, which may be referred to as the persistent storage device controller 112 (or simply as the persistent memory controller 112).

The NAND flash memory may be read or written at the granularity of a flash page, which may be between 8 kB and 16 kB in size. Before the flash memory page is reprogrammed with new data, the flash memory page may first be erased. The granularity of an erase operation may be one NAND block, or “physical block”, which may include, for example, between 128 and 256 pages.

Because the granularity of erase and program operations are different, garbage collection (GC) may be used to free up partially invalid physical blocks and to make room for new data. The garbage collection operation may (i) identify fragmented flash blocks, in which a large proportion (for example, most) of the pages are invalid, and (ii) erase each such physical block. When garbage collection is completed, the pages in an erased physical block may be recycled and added to a free list in the Flash Translation Layer.

The non-volatile memory 116 (for example, if the non-volatile memory 116 includes or is flash memory) may be capable of being programmed and erased only a limited number of times. This may be referred to as the maximum number of program/erase cycles (P/E cycles) the non-volatile memory 116 can sustain. To maximize the life of the persistent storage device 104, the persistent storage device controller 112 may endeavor to distribute write operations across all of the physical blocks of the non-volatile memory 116; this process may be referred to as wear-leveling.

A mechanism that may be referred to as “read disturb” may reduce persistent storage device reliability. A read operation on a NAND flash memory cell may, for example, cause the threshold voltage of nearby unread flash cells in the same physical block to change. Such disturbances may change the logical states of the unread cells, and may lead to uncorrectable error-correcting code (ECC) read errors, degrading flash endurance.

To avoid this result, the Flash Translation Layer may have a counter of the total number of reads to a physical block since the last erase operation. The contents of the physical block may be copied to a new physical block, and the physical block may be recycled, when the counter exceeds a threshold (for example, 50,000 reads for Multi-Level Cell), to avoid irrecoverable read disturb errors. As an alternative, in some embodiments, a test read may periodically be performed within the physical block to check the error-correcting code error rate; if the error rate is close to the error-correcting code capability, the data may be copied to a new physical block.

Because of the relocation of data performed by various operations (for example, garbage collection) in the persistent storage device 104, the amount of data that is erased and rewritten may be larger than the data written to the persistent storage device 104 by the host. Each time data are relocated without being changed by the host system, a quantity referred to as write amplification is increased, and the life of the non-volatile memory 116 may be reduced. Write amplification may be measured as the ratio of (i) the number of writes committed to the flash memory to (ii) the number of writes coming from the host system.

FIG. 1C is a system-level diagram of a system capable of video processing (for example, video decoding) operations, in accordance with some example embodiments of the disclosure. Within each server 100, a host 102 is connected to a persistent storage device 104 (which may be, for example, a solid state drive (SSD)). The persistent storage device 104 may have (as in the embodiments of FIGS. 1A and 1B) a form factor that is any one of a plurality of form factors suitable for persistent storage devices, including but not limited to a 2.5″ form factor, a 1.8″ form factor, a MO-297 form factor, a MO-300 form factor, a M.2 form factor, and Enterprise and Data Center SSD Form Factor (EDSFF). One or more of the servers 100 may perform video processing (for example, one or more of the persistent storage devices 104 (which may be computational storage devices) of the servers 100 may perform video processing using parallel operations as discussed in further detail below).

The persistent storage device 104 may have an electrical interface (which may be referred to as a “host interface”) 106, through which the persistent storage device 104 may be connected to the host 102, that (as in the embodiments of FIGS. 1A and 1B) may be any one of a plurality of interfaces suitable for persistent storage devices, including Peripheral Component Interconnect (PCI), PCI express (PCIe), Ethernet, Small Computer System Interface (SCSI), Serial AT Attachment (SATA), and Serial Attached SCSI (SAS) or Universal Flash Storage (UFS). A Universal Flash Storage may include a plurality of serial interfaces each of which may include a full duplex high-speed serial lane. The persistent storage device 104 may include an interface circuit which operates as an interface adapter between the host interface 106 and one or more internal interfaces in the persistent storage device 104.

As used herein, “persistent memory” means non-volatile memory, for example, persistent memory is non-volatile memory, which may continue to store data when electrical power is not supplied to the persistent memory. The persistent storage device 104 may include an interface circuit 106 which operates as an interface adapter between the host interface and one or more internal interfaces in the persistent storage device 104.

The host interface may be used by the host 102, to communicate with the persistent storage device 104, for example, by sending write and read commands, which may be received, by the persistent storage device 104, through the host interface 106. In some embodiments, the host 102 may send elements of an input feature map to the persistent storage device 104 through the host interface 106 and the persistent storage device 104 may calculate products of the elements of the input feature map and the weights. The host interface may also be used by the persistent storage device 104 to perform data transfers to and from system memory of the host 102. Such data transfers may be performed using direct memory access (DMA). For example, when the host 102 sends a write command to the persistent storage device 104, the persistent storage device 104 may fetch the data to be written to the non-volatile memory 116 from the host memory 110 of the host device 102 using direct memory access, and the persistent storage device 104 may then save the fetched data to the non-volatile memory 116.

Similarly, if the host 102 sends a read command to the persistent storage device 104, the persistent storage device 104 may read the requested data (i.e., the data specified in the read command) from the non-volatile memory 116 and save the requested data in the host memory 110 of the host device 102 using direct memory access. The persistent storage device 104 may store data in a persistent memory, for example, not-AND (NAND) flash memory, for example, in memory dies containing memory cells, each of which may be, for example, a Single-Level Cell (SLC), a Multi-Level Cell (MLC), or a Triple-Level Cell (TLC).

The persistent storage device 104 may (as in the embodiments of FIGS. 1A and 1B) store data in a persistent memory, for example, not-AND (NAND) flash memory, for example, in memory dies containing memory cells, each of which may be, for example, a Single-Level Cell (SLC), a Multi-Level Cell (MLC), or a Triple-Level Cell (TLC), and/or the like.

A Flash Translation Layer (FTL) of the persistent storage device 104 may provide a mapping between logical addresses used by the host 102 and physical addresses of the data in the persistent memory. The persistent storage device 104 may also include (i) a buffer (which may include, for example, consist of, dynamic random-access memory (DRAM)), and (ii) a persistent memory controller (for example, a flash controller) for providing suitable signals to the persistent memory. Some or all of the host interface, the Flash Translation Layer, the buffer, and the persistent memory controller may be implemented in a processing circuit, which may be referred to as the persistent storage device controller.

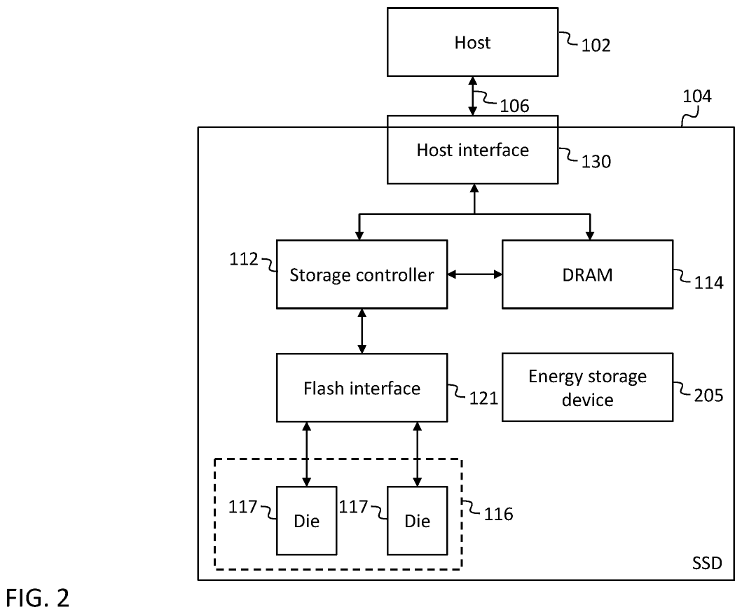

Referring to FIG. 2, as mentioned above, in a computing system with a host 102 and a persistent storage device 104, the host 102 may periodically send write commands to the persistent storage device 104, for example, for the purpose of saving data (which may accompany the write command) to non-volatile memory 116 of the persistent storage device 104. The persistent storage device 104 may receive the write command and temporarily store the data in a storage memory 114 (or “buffer”) (which may include, or consist of, volatile memory, for example, dynamic random-access memory (DRAM)). The use of a storage memory 114 in this manner may, for example, make possible data transfer bandwidths (for example, via direct memory access) between the host 102 and the persistent storage device 104, that significantly exceed the bandwidth of the non-volatile memory 116 of the persistent storage device 104.

The persistent storage device 104 may include an energy storage device 205 (for example, a battery or a capacitor) and in the event of a power failure, the persistent storage device 104 may, to avoid data loss, consume power from the energy storage device 205 while copying data from the buffer to the non-volatile memory 116.

In some embodiments, the host interface 106 implements a memory-access interface, such as the Compute Express Link (CXL) memory-access interface (CXL.mem). When such an interface is implemented, the persistent storage device 104 may be memory-mapped, for example, the interface may enable the host processor 108 of the host 102 to communicate with the persistent storage device 104 by performing load and store instructions. For example, to write data to the storage memory 114 of the persistent storage device 104, the host processor 108 of the host 102 may execute a store instruction to a first memory address, in the address space of the host processor 108 of the host 102, that is mapped to an address (for example, a second address) in the storage memory 114. In this circumstance, the executing, by the host processor 108 of the host 102 of a store instruction for storing a data word in the first memory address may have the effect of causing the data word to be written to the second memory address in the storage memory 114 of the persistent storage device 104.

The use of a memory-access interface may have the effect of increasing the advantages of a large storage memory 114 of the persistent storage device 104, because (i) the ability of the host processor 108 of the host 102 to access the storage memory 114 of the persistent storage device 104 as mapped memory may make the use of the storage memory 114 of the persistent storage device 104 as auxiliary memory of the host 102 significantly more efficient (than alternative access modes involving, for example, calls to driver functions) and because (ii) the ability of the host processor 108 of the host 102 to access the storage memory 114 of the persistent storage device 104 as mapped memory may make it more feasible for the software running on the host processor 108 of the host 102 to take advantage of large blocks of storage.

As such, as the technology of persistent storage devices evolves, the sizes of the buffers in such devices may increase significantly, and the energy storage capacity of the energy storage device 205 may, if it is sized so as to be able to power the device while the entire buffer is copied to the non-volatile memory 116, may become sufficiently large to significantly increase the cost of the persistent storage device 104 or to constrain the packaging options for the persistent storage device 104.

In some embodiments, therefore, the energy storage device 205 is sized so as to be able power the device while a portion of the buffer (which may be less than the entire buffer) is copied to the non-volatile memory 116. In such an embodiment, the persistent storage device 104 may provide a mechanism for the host 102 to trigger, or initiate, the copying of a portion of the buffer to the non-volatile memory 116 of the persistent storage device 104.

If the host interface 106 implements a memory-access interface (such as the Compute Express Link memory-access interface (CXL.mem)), then the initiating of a buffer flush may be performed, from the perspective of the host processor 108 of the host 102, by executing one or more load or store instructions. For example, a register of the persistent memory controller 112 may be (i) mapped to the memory address space of the host processor 108 of the host 102 through the memory-access interface and (ii) configured as a register (which may be referred to as a trigger register) that may be used to initiate (or “trigger”) a flush of the storage memory 114 to the non-volatile memory 116. For example, a flush of the storage memory 114 to the non-volatile memory 116 may be initiated when the trigger register is accessed by the host 102 (for example, accessed via a load instruction executed by the host processor 108 of the host 102, or accessed via a store instruction executed by the host processor 108 of the host 102, or accessed via either a load instruction executed by the host processor 108 of the host 102, or via a store instruction executed by the host processor 108).

Other registers of the host processor 108 of the host 102, or memory locations in the storage memory 114, may be used, by the host processor 108 of the host 102, to configure parameters of the copying operation to the non-volatile memory 116, for example, to specify a start address and an end address of the region of the storage memory 114 that is to be copied to the non-volatile memory 116 (for example, by storing the start address and end addresses in respective registers or memory locations of the persistent storage device 104), or to specify an amount of data that is to be copied to the non-volatile memory 116 (for example, by storing the amount in a respective register or memory location of the persistent storage device 104), or to specify a fraction of the size of the storage memory 114 that is to be copied to the non-volatile memory (for example, by storing the fraction in a respective register or memory location of the persistent storage device 104), or to specify a fraction of the data stored in the storage memory 114 that is to be copied to the non-volatile memory (for example, by storing the fraction in a respective register or memory location of the persistent storage device 104), or to specify an amount of data that is to remain in the storage memory 114 after copying to the non-volatile memory 116 (for example, by storing the amount in a respective register or memory location of the persistent storage device 104). For example, if the energy storage capacity of the energy storage device 205 is sufficient to copy a certain quantity of data (for example, 1 gigabyte of data) to the non-volatile memory 116, then the host processor 108 of the host 102 may specify (for example, by writing to a memory location or register designated for that purpose) that this amount of data should remain in the storage memory 114 after the copying of the storage memory 114 to the non-volatile memory 116 of the persistent storage device 104 has been performed. In such a circumstance, the initiating of a flush by the host processor 108 of the host 102 may ensure that no data loss will occur if a power failure occurs immediately after the flush has been completed.

For example, the host 102 may send a command to the persistent storage device 104 to copy all of the data stored in the buffer to the non-volatile memory 116, or it may specify a portion of the buffer of the persistent storage device 104 to be copied to the non-volatile memory 116 of the persistent storage device 104. In this manner, the host 102 may participate in the protection against data loss, and, for example, when instructing the persistent storage device 104 to copy a portion of the buffer to non-volatile memory 116, the host 102 may prioritize data that would be more difficult to recreate.

In some embodiments, a flush to non-volatile memory 116 of a portion of the storage memory 114 initiated by the host processor 108 of the host 102 may be implemented (for example, by suitable choice of the size of the energy storage device 205) to exhibit a low rate of failure, for example, to fail only if a component of the persistent storage device 104 is faulty or has failed, or to have a likelihood of failure, per instance of host-initiated copying to the non-volatile memory 116, of less than 1 in 100,000 or less than 1 in 1,000,000, or less than 1 in 10,000,000. This may be higher reliability than the global persistent flush implemented in some persistent storage devices 104, which may be a best-effort flush with low, or uncertain, or poorly characterized reliability.

In some embodiments, the persistent storage device 104 has the capability to perform processing operations on the data stored in the non-volatile memory 116 (in such an embodiment the persistent storage device 104 may be referred to as a computational storage device). For example, the persistent memory controller 112 may read data (or “raw data”) from the non-volatile memory 116 and decompress the data, or decrypt the data, or perform other processing (for example, multiply the data, which may include weights of a neural network, by elements of an input feature map). In such an embodiment, the loss of some of the processed data in the storage memory 114 (for example, decrypted data or decompressed data) may in some circumstances be acceptable because the cost of re-creating it may be relatively low.

The persistent storage device 104 may report various pieces of information to the host 102, such as the size of the storage memory 114, the energy storage capacity of the energy storage device 205, the degree of charge of the energy storage device 205, an estimate of the energy (for example, in joules) stored in the energy storage device 205, the energy required, per unit of data, to copy data from the storage memory 114 to the non-volatile memory 116 of the persistent storage device 104 (for example, in units of joules per gigabyte), or the amount of data currently stored in the storage memory 114.

In some embodiments, the persistent storage device 104 may report different categories of data separately, for example, it may report, separately, (i) data stored in the storage memory 114 that was received from the host, or calculated based on data received from the host (which may be referred to as host data) and (ii) data stored in the storage memory 114 that was generated by the persistent memory controller 112, for example, based on data read from the non-volatile memory 116 (which may be referred to as generated data, or as data generated by the storage device). In some embodiments, the reporting may be triggered by the executing, by the host processor 108 of the host 102, of a memory-addressed instruction. As used herein, a memory-addressed instruction is an instruction that is delivered to the persistent storage device 104 as a result of a load or store instruction, performed, by the host processor 108 of the host 102, on an address that is mapped to the persistent storage device 104. For example, a register of the persistent memory controller 112 may be configured as a reporting register, and when the host processor 108 of the host 102 executes a store instruction to store an integer in the reporting register, the persistent storage device 104 may, in response, report, to the host 102, the value of a parameter corresponding to the integer. The persistent storage device 104 may report (or “send”) the parameter value to the host 102 by making the parameter available (for example, by storing the parameter in) an address mapped to the address space of the host processor 108 of the host 102.

The data obtained by the host 102 as a result of such reporting may be used by the host 102 to determine when to initiate a copying of the storage memory 114 to the non-volatile memory 116 of the persistent storage device 104, or what amount of data is to be copied when data is next copied from the storage memory 114 to the non-volatile memory 116 of the persistent storage device 104. For example, the host 102 may instruct the persistent storage device 104 (by writing suitable values to configuration registers of the persistent storage device 104) to copy, from the storage memory 114, to the non-volatile memory 116, an amount of host data such that the amount of host data remaining in the storage memory 114 will be sufficiently small to be copied to the non-volatile memory 116 under power from only the energy storage device 205 (for example, in the event of a power failure). In some embodiments, when the persistent storage device 104 receives an instruction from the host 102 to copy a portion of the storage memory 114 to the non-volatile memory 116 of the persistent storage device 104, the persistent storage device 104 determines whether the quantity of host data in the storage memory 114 exceeds a threshold, and, if it does, the persistent storage device 104 copies a portion of the host data in the storage memory 114 (e.g., a portion at least equal in size to the amount by which the quantity of host data in the storage memory 114 exceeds the threshold) to the non-volatile memory 116 of the persistent storage device 104.

In some embodiments, if the host processor 108 of the host 102 does not specify which memory locations of the storage memory 114 are to be copied to the non-volatile memory 116 (for example, by specifying a range of addresses), and if the host instead specifies, for example, the amount of data to be copied, or the amount of data to remain in the storage memory 114 after copying, the persistent storage device 104 may determine, using any of various suitable methods, which data to copy to the non-volatile memory 116 and which data to leave in the storage memory 114. For example, the persistent storage device 104 may employ a least-recently-used (LRU) method to select data to be copied, or it may first copy all host data to the non-volatile memory 116 before copying generated data to the non-volatile memory 116. For example, in some embodiments, a first portion of the storage memory 114 may contain host data. The persistent storage device 104 may read raw data (or “first data”) from the non-volatile memory, process the raw data, to form first processed data (which may be generated data), and store the first processed data in a second portion of the storage memory 114. This portion of the storage memory 114 may be copied to the non-volatile memory 116 (if at all) only after all of the host data has been copied to the non-volatile memory 116.

In some embodiments, another device may send a command to the persistent storage device 104 to copy some or all of the data stored in the buffer to the non-volatile memory 116, in a manner similar to that employed by the host in embodiments described herein. In some embodiments, the host interface 106 implements an input-output interface, such as the Compute Express Link (CXL) input-output interface (CXL.io) (in addition to the memory-access interface) and the input-output interface may be used by the host 102, or by another device, to send a command to the persistent storage device 104 to copy some or all of the data stored in the buffer to the non-volatile memory 116.

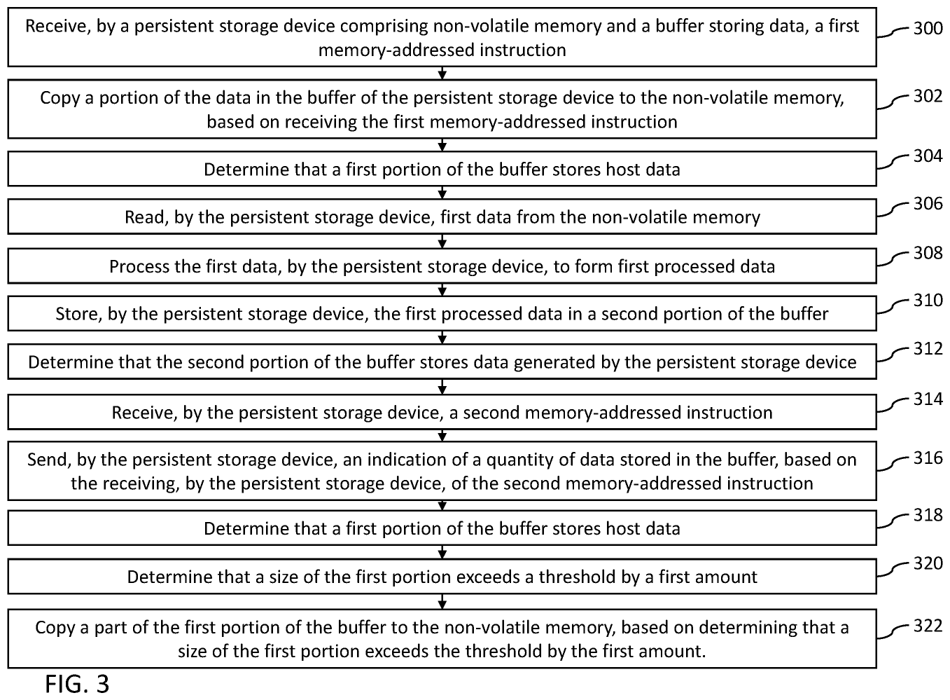

FIG. 3 is a flowchart of a method, in some embodiments. The method includes: receiving, at 300, by a persistent storage device including non-volatile memory and a buffer storing data, a first memory-addressed instruction; copying, at 302, a portion of the data in the buffer of the persistent storage device to the non-volatile memory, based on receiving the first memory-addressed instruction; determining, at 304, that a first portion of the buffer stores host data; reading, at 306, by the persistent storage device, first data from the non-volatile memory; processing, at 308, the first data, by the persistent storage device, to form first processed data; storing, at 310, by the persistent storage device, the first processed data in a second portion of the buffer; determining, at 312, that the second portion of the buffer stores data generated by the persistent storage device; receiving, at 314, by the persistent storage device, a second memory-addressed instruction; sending, at 316, by the persistent storage device, an indication of a quantity of data stored in the buffer, based on the receiving, by the persistent storage device, of the second memory-addressed instruction; determining, at 318, that a first portion of the buffer stores host data; determining, at 320, that a size of the first portion exceeds a threshold by a first amount; and copying, at 322, a part of the first portion of the buffer to the non-volatile memory, based on determining that a size of the first portion exceeds the threshold by the first amount.

As used herein, “a portion of” something means “at least some of” the thing, and as such may mean less than all of, or all of, the thing. As such, “a portion of” a thing includes the entire thing as a special case, i.e., the entire thing is an example of a portion of the thing. Similarly, “a part of” a thing means “at least some of” the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

The background provided in the Background section of the present disclosure section is included only to set context, and the content of this section is not admitted to be prior art. Any of the components or any combination of the components described (e.g., in any system diagrams included herein) may be used to perform one or more of the operations of any flow chart included herein. Further, (i) the operations are example operations, and may involve various additional steps not explicitly covered, and (ii) the temporal order of the operations may be varied.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Some embodiments may include features of the following numbered statements.

1. A method comprising:
receiving, by a persistent storage device comprising non-volatile memory and a buffer storing data, a first memory-addressed instruction; and
copying a portion of the data in the buffer of the persistent storage device to the non-volatile memory, based on receiving the first memory-addressed instruction.

2. The method of statement 1, wherein the portion of the buffer is specified by a start address in a start address register of the persistent storage device and an end address in an end address register of the persistent storage device.

3. The method of statement 1 or statement 2, wherein:
the portion of the buffer has a first size, and
the first size is based on a value in a first register of the persistent storage device.

4. The method of any one of the preceding statements, further comprising:
determining that a first portion of the buffer stores host data; and
determining that a second portion of the buffer stores data generated by the persistent storage device.

5. The method of any one of the preceding statements, further comprising:
determining that a first portion of the buffer stores host data; and
determining that a second portion of the buffer stores data generated by the persistent storage device,
wherein:
   the copying of a portion of the data in the buffer of the persistent storage device to the non-volatile memory comprises copying a part of the first portion of the buffer.

6. The method of any one of the preceding statements, further comprising:
determining that a first portion of the buffer stores host data;
reading, by the persistent storage device, first data from the non-volatile memory; processing the first data, by the persistent storage device, to form first processed data;
storing, by the persistent storage device, the first processed data in a second portion of the buffer; and
determining that the second portion of the buffer stores data generated by the persistent storage device,
wherein:
   the copying of a portion of the data in the buffer of the persistent storage device to the non-volatile memory comprises copying a part of the first portion of the buffer.

7. The method of any one of the preceding statements, further comprising:
receiving, by the persistent storage device, a second memory-addressed instruction; and
sending, by the persistent storage device, an indication of a quantity of data stored in the buffer, based on the receiving, by the persistent storage device, of the second memory-addressed instruction.

8. The method of any one of the preceding statements, further comprising:
determining that a first portion of the buffer stores host data;
determining that a size of the first portion exceeds a threshold; and
copying a part of the first portion of the buffer to the non-volatile memory, based on determining that a size of the first portion exceeds a threshold.

9. The method of any one of the preceding statements, further comprising:
determining that a first portion of the buffer stores host data;
determining that a size of the first portion exceeds a threshold by a first amount; and
copying a part of the first portion of the buffer to the non-volatile memory, based on determining that a size of the first portion exceeds the threshold by the first amount,
wherein a size of the part of the first portion is greater than or equal to the first amount.

10. The method of any one of the preceding statements, further comprising:
receiving, by the persistent storage device, a second memory-addressed instruction; and
sending, by the persistent storage device, an indication of a quantity of host data stored in the buffer, based on the receiving, by the persistent storage device, of the second memory-addressed instruction.

11. A system, comprising:
a persistent storage device comprising:
a non-volatile memory;
a buffer; and
a processing circuit configured:
   to store data in the buffer;
   to receive a first memory-addressed instruction; and
   to copy a portion of the data in the buffer to the non-volatile memory, based on receiving the first memory-addressed instruction.

12. The system of statement 11, wherein:
the processing circuit is further configured:
   to determine that a first portion of the buffer stores host data, and
   to determine that a second portion of the buffer stores data generated by the persistent storage device, and
the copying of a portion of the data in the buffer of the persistent storage device to the non-volatile memory comprises copying a part of the first portion of the buffer.

13. The system of statement 11 or statement 12, wherein:
the processing circuit is further configured:
   to determine that a first portion of the buffer stores host data;
   to read first data from the non-volatile memory;
   to process the first data, to form first processed data;
   to store the first processed data in a second portion of the buffer; and
   to determine that the second portion of the buffer stores data generated by the persistent storage device; and
the copying of a portion of the data in the buffer of the persistent storage device to the non-volatile memory comprises copying a part of the first portion of the buffer.

14. The system of any one of statements 11 to 13, wherein:
the processing circuit is further configured:
   to receiving a second memory-addressed instruction; and
   to send an indication of a quantity of data stored in the buffer, based on the receiving of the second memory-addressed instruction.

15. The system of any one of statements 11 to 14, wherein:
the processing circuit is further configured:
   to determine that a first portion of the buffer stores host data;
   to determine that a size of the first portion exceeds a threshold; and
   to copy a part of the first portion of the buffer to the non-volatile memory, based on determining that a size of the first portion exceeds a threshold.

16. The system of any one of statements 11 to 15, wherein:
the processing circuit is further configured:
   to determine that a first portion of the buffer stores host data;
   to determine that a size of the first portion exceeds a threshold by a first amount; and
   to copy a part of the first portion of the buffer to the non-volatile memory, based on determining that a size of the first portion exceeds the threshold by the first amount,
wherein a size of the part of the first portion is greater than or equal to the first amount.

17. The system of any one of statements 11 to 16, wherein:
the processing circuit is further configured:
   to receive a second memory-addressed instruction; and
   to send an indication of a quantity of data stored in the buffer, based on the receiving of the second memory-addressed instruction.

18. A persistent storage device, comprising:
a persistent storage device comprising:
a non-volatile memory;
a buffer;
a processing circuit; and
memory,
the memory storing instructions that, when executed by the processing circuit, cause the processing circuit to perform a method, the method comprising:
   receiving, by a persistent storage device comprising a buffer storing data and non-volatile memory, a first memory-addressed instruction; and
   copying a portion of the data in the buffer of the persistent storage device to the non-volatile memory, based on receiving the first memory-addressed instruction.

19. The persistent storage device of statement 18, wherein the method further comprises:
determining that a first portion of the buffer stores host data;
determining that a second portion of the buffer stores data generated by the persistent storage device; and
the copying of a portion of the data in the buffer of the persistent storage device to the non-volatile memory comprises copying a part of the first portion of the buffer.

20. The persistent storage device of statement 18 or statement 19, wherein the method further comprises:
determining that a first portion of the buffer stores host data;
reading, by the persistent storage device, raw data from the non-volatile memory;
processing the raw data, by the persistent storage device, to form first processed data;
storing, by the persistent storage device, the first processed data in a second portion of the buffer;
determining that a second portion of the buffer stores data generated by the persistent storage device; and
the copying of a portion of the data in the buffer of the persistent storage device to the non-volatile memory comprises copying a part of the first portion of the buffer.

Although exemplary embodiments of a system and method for host-initiated buffer flush in a persistent storage device have been specifically described and illustrated herein, many modifications and variations will be apparent to those skilled in the art. Accordingly, it is to be understood that a system and method for host-initiated buffer flush in a persistent storage device constructed according to principles of this disclosure may be embodied other than as specifically described herein. The invention is also defined in the following claims, and equivalents thereof.

What is claimed is:

1. A method comprising:
receiving, by a persistent storage device comprising non-volatile memory and a buffer storing data, a first memory-addressed instruction; and
copying a portion of the data in the buffer of the persistent storage device to the non-volatile memory, based on receiving the first memory-addressed instruction.

2. The method of claim 1, wherein the portion of the buffer is specified by a start address in a start address register of the persistent storage device and an end address in an end address register of the persistent storage device.

3. The method of claim 1, wherein:
the portion of the buffer has a first size, and
the first size is based on a value in a first register of the persistent storage device.

4. The method of claim 1, further comprising:
determining that a first portion of the buffer stores host data; and
determining that a second portion of the buffer stores data generated by the persistent storage device.

5. The method of claim 1, further comprising:
determining that a first portion of the buffer stores host data; and
determining that a second portion of the buffer stores data generated by the persistent storage device,
wherein:
the copying of a portion of the data in the buffer of the persistent storage device to the non-volatile memory comprises copying a part of the first portion of the buffer.

6. The method of claim 1, further comprising:
determining that a first portion of the buffer stores host data;
reading, by the persistent storage device, first data from the non-volatile memory;
processing the first data, by the persistent storage device, to form first processed data;
storing, by the persistent storage device, the first processed data in a second portion of the buffer; and
determining that the second portion of the buffer stores data generated by the persistent storage device,
wherein:
the copying of a portion of the data in the buffer of the persistent storage device to the non-volatile memory comprises copying a part of the first portion of the buffer.

7. The method of claim 1, further comprising:
receiving, by the persistent storage device, a second memory-addressed instruction; and
sending, by the persistent storage device, an indication of a quantity of data stored in the buffer, based on the receiving, by the persistent storage device, of the second memory-addressed instruction.

8. The method of claim 1, further comprising:
determining that a first portion of the buffer stores host data;
determining that a size of the first portion exceeds a threshold; and
copying a part of the first portion of the buffer to the non-volatile memory, based on determining that a size of the first portion exceeds a threshold.

9. The method of claim 1, further comprising:
determining that a first portion of the buffer stores host data;
determining that a size of the first portion exceeds a threshold by a first amount; and
copying a part of the first portion of the buffer to the non-volatile memory, based on determining that a size of the first portion exceeds the threshold by the first amount,
wherein a size of the part of the first portion is greater than or equal to the first amount.

10. The method of claim 1, further comprising:
receiving, by the persistent storage device, a second memory-addressed instruction; and
sending, by the persistent storage device, an indication of a quantity of host data stored in the buffer, based on the receiving, by the persistent storage device, of the second memory-addressed instruction.

11. A system, comprising:
a persistent storage device comprising:
a non-volatile memory;
a buffer; and
a processing circuit configured:
to store data in the buffer;
to receive a first memory-addressed instruction; and
to copy a portion of the data in the buffer to the non-volatile memory, based on receiving the first memory-addressed instruction.

12. The system of claim 11, wherein:
the processing circuit is further configured:
to determine that a first portion of the buffer stores host data, and to determine that a second portion of the buffer stores data generated by the persistent storage device, and
the copying of a portion of the data in the buffer of the persistent storage device to the non-volatile memory comprises copying a part of the first portion of the buffer.

13. The system of claim 11, wherein:
the processing circuit is further configured:
to determine that a first portion of the buffer stores host data;
to read first data from the non-volatile memory;
to process the first data, to form first processed data;
to store the first processed data in a second portion of the buffer; and
to determine that the second portion of the buffer stores data generated by the persistent storage device; and
the copying of a portion of the data in the buffer of the persistent storage device to the non-volatile memory comprises copying a part of the first portion of the buffer.

14. The system of claim 11, wherein:
the processing circuit is further configured:
to receiving a second memory-addressed instruction; and
to send an indication of a quantity of data stored in the buffer, based on the receiving of the second memory-addressed instruction.

15. The system of claim 11, wherein:
the processing circuit is further configured:
to determine that a first portion of the buffer stores host data;
to determine that a size of the first portion exceeds a threshold; and
to copy a part of the first portion of the buffer to the non-volatile memory, based on determining that a size of the first portion exceeds a threshold.

16. The system of claim 11, wherein:
the processing circuit is further configured:
to determine that a first portion of the buffer stores host data;
to determine that a size of the first portion exceeds a threshold by a first amount; and
to copy a part of the first portion of the buffer to the non-volatile memory, based on determining that a size of the first portion exceeds the threshold by the first amount,
wherein a size of the part of the first portion is greater than or equal to the first amount.

17. The system of claim 11, wherein:
the processing circuit is further configured:
to receive a second memory-addressed instruction; and
to send an indication of a quantity of data stored in the buffer, based on the receiving of the second memory-addressed instruction.

18. A persistent storage device, comprising:
a persistent storage device comprising:
a non-volatile memory;
a buffer;
a processing circuit; and
memory,
the memory storing instructions that, when executed by the processing circuit, cause the processing circuit to perform a method, the method comprising:
receiving, by a persistent storage device comprising a buffer storing data and non-volatile memory, a first memory-addressed instruction; and
copying a portion of the data in the buffer of the persistent storage device to the non-volatile memory, based on receiving the first memory-addressed instruction.

19. The persistent storage device of claim 18, wherein the method further comprises:
determining that a first portion of the buffer stores host data;
determining that a second portion of the buffer stores data generated by the persistent storage device; and
the copying of a portion of the data in the buffer of the persistent storage device to the non-volatile memory comprises copying a part of the first portion of the buffer.

20. The persistent storage device of claim 18, wherein the method further comprises:
determining that a first portion of the buffer stores host data;
reading, by the persistent storage device, raw data from the non-volatile memory;
processing the raw data, by the persistent storage device, to form first processed data;
storing, by the persistent storage device, the first processed data in a second portion of the buffer;
determining that a second portion of the buffer stores data generated by the persistent storage device; and
the copying of a portion of the data in the buffer of the persistent storage device to the non-volatile memory comprises copying a part of the first portion of the buffer.
